(19) United States
(12) Patent Application Publication
(10) Pub. No.: US 2002/0165763 A1
(43) Pub. Date: Nov. 7, 2002

(54) System and method for implementing technical change in an organization having multiple hierarchies

(75) Inventors: Robert R. Friedlander, Southbury, CT (US); Kathleen Covert Kimmel, Louisville, CO (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 09/849,291

(22) Filed: May 4, 2001

(51) Int. Cl. G06F 17/60

(52) U.S. Cl. 705/11

(57) ABSTRACT

A system and method for implementing technical change in an organization having multiple hierarchies. Specifically, the present invention provides an analysis system that predicts a response to technical change. Based on the response, corrective actions can be implemented to minimize or eliminate any adverse reaction to the change. To predict the response, the analysis system will query selected hierarchies in the organization. Based on a set of responses to the queries, a baseline response is determined. The baseline line response is then quantified into a raw score and modified to yield a skill score. The skill score is then compared to a required or “normal” score to determine any difference between the two. Based on the difference, the potential response to the technical change can be determined.

### BACKGROUND OF THE INVENTION

1. Technical Field

The present invention generally relates to a system and method for implementing technical change in an organization having multiple hierarchies. More particularly, the system and method of the present invention predicts a response of an organization to technical change, and then recommends corrective actions so that the technical change can be implemented without complication.

2. Background Art

As the use of Information Technology (“IT”) in business grows, business organizations are constantly implementing new technologies. Oftentimes, the implementation of new technology requires some technical change within the organization. Such change could include, for example, implementation of a new software application, installation of new hardware, etc. However, such change is commonly met with resistance within the organization. This resistance often includes refusal by employees to utilize the new technology. Accordingly, the new technology could amount to a waste of the organization's resources. Proper preparation in advance of the technical change could minimize or eliminate such waste. For example, if an organization could adapt their current practices and procedures in advance of the technical change, adverse reactions to the change could be minimized or eliminated. Such preparation, however, requires an accurate measurement of how the organization would respond to the proposed technical change. If the measurement is known in advance, certain corrective actions could be implemented to circumvent any adverse reactions to the change. Currently, no existing technology provides such a system. This is largely because many organizations include multiple hierarchies or personnel units such as management levels, departments, ends users, etc. Each hierarchy may have different responsibilities and/or skills. Accordingly, different factors could be required to predict how each hierarchy will respond to the technical change.

In view of the foregoing, there exists a need for a system and method that accurately predicts a response to technical change for an organization having multiple hierarchies. In addition, a need exists for a system and method that can measure a response level so that corrective actions can be implemented to minimize the adverse reactions to the technical change.

### SUMMARY OF THE INVENTION

The present invention overcomes the drawbacks of existing methods and systems by providing a system and method for implementing technical change in an organization having multiple hierarchies. Specifically, the present invention provides an analysis system that uses both qualitative and quantitative measures to determine a predicted response to technical change. The predicted response is then compared to a “normal” or required level to determine any difference. Based on the difference, if any, corrective actions are recommended. The system and method of the present invention allow the technical change to be implemented with little or no adverse reaction from the hierarchies within the organization.

According to a first aspect of the present invention, a method for implementing technical change in an organization having multiple hierarchies is provided. The method comprises the steps of: (1) querying a hierarchy in the organization to obtain a baseline response; (2) quantifying the baseline response into a raw score; (3) modifying the raw score to yield a skill score; and (3) comparing the skill score to a predetermined required score to determine a predicted response to the technical change.

According to a second aspect of the present invention, a method for implementing technical change in an organization having multiple hierarchies is provided. The method comprises the steps of: (1) querying each of the hierarchies in the organization; (2) receiving a set of hierarchy responses to the querying; (3) quantifying the set of responses into a raw score; (4) modifying the raw score to yield a skill score; (5) comparing the skill score to a predetermined required score to determine a predicted response to the technical change; (6) recommending a corrective action based on the predicted response; and (7) implementing the technical change in the organization.

According to a third aspect of the present invention, a program product stored on a recordable medium for implementing technical change in an organization having multiple hierarchies is provided. When executed, the program product comprises: (1) a hierarchy response system for receiving a set of hierarchy responses to queries; (2) a quantification system for quantifying the set of responses into a raw score; and (3) a modification system for modifying the raw score into a skill score.

According to a fourth aspect of the present invention, a system for implementing technical change in an organization having multiple hierarchies is provided. The system comprises: (1) a hierarchy response system for receiving a set of hierarchy responses to queries; (2) a quantification system for quantifying inputted responses into a raw score; and (3) a modification system for modifying the raw score into a skill score.

According to a fifth aspect of the present invention, a system for implementing technical change in an organization having multiple hierarchies is provided. The system comprises: (1) means for receiving a set of hierarchy responses to queries; (2) means for quantifying inputted responses into a raw score; and (3) means for modifying the raw score into a skill score.

Therefore, the present invention provides a system and method for implementing technical change in an organization having multiple hierarchies.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a computer system having an analysis system, according to the present invention.

FIG. 2 depicts a box diagram of the analysis system of FIG. 1.

FIG. 3 depicts a first table of queries and hierarchies.

FIG. 4 depicts a second table of queries and hierarchies.

FIG. 5 depicts a third table of queries and hierarchies.

FIG. 6 depicts a fourth table of queries and hierarchies.

FIG. 7 depicts a fifth table of queries and hierarchies.

FIG. 8 depicts a flow chart of a first method, according to the present invention.

FIG. 9 depicts a flow chart of a second method, according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience, this description will include the following sections:

I. Definitions

II. Overview

III. Computer System

IV. Analysis System

I. Definitions

Organization—a business entity, or the like, that is undergoing technical change.

Hierarchy—a personnel unit such as a management level, department, position type, or individual in an organization.

Query—a set of questions posed to at least one hierarchy within an organization to predict a response to a technical change.

Baseline Response—a set of responses to a query.

Raw Score—a baseline response quantified into a value.

Modifier—a value that is used to modify a raw score.

Skill Score—the resulting value of a mathematical operation performed on a raw score by a modifier.

Required Score—a value that represents a normal or expected response to a technical change.

I. Overview

Generally stated, the present invention provides a system and method for implementing technical change in an organization having multiple hierarchies. Such technical change could include, for example, implementation of a new software application, installation of new hardware, etc. The system and method begins by querying one or more hierarchies in the organization. A set of responses to the querying referred to as a baseline response is then collected. Depending on the analysis being made, the baseline response could represent a set of responses from a single hierarchy, multiple hierarchies, or the entire organization. Once determined, the baseline response is quantified into a raw score, which can then be modified to yield a skill score. The skill score is then compared to a predetermined required score to determine any difference between the two. The difference can then be examined to pinpoint potential problems resulting from the technical change (i.e., identify a potential response to the change), and to recommend corrective actions to the organization. When implemented, the corrective actions help the organization minimize or eliminate adverse response to the technical change. It should be appreciated that the system and method of the present invention can be used prior to, during, and/or after the technical change has been implemented.

By querying selected hierarchies of an organization using specially developed queries (as described below), the present invention uses both qualitative and quantitative measures to accurately predict how an organization will respond to technical change. This allows an organization to reduce or eliminate the waste of resources caused by adverse reaction to the technical change.

II. Computer System

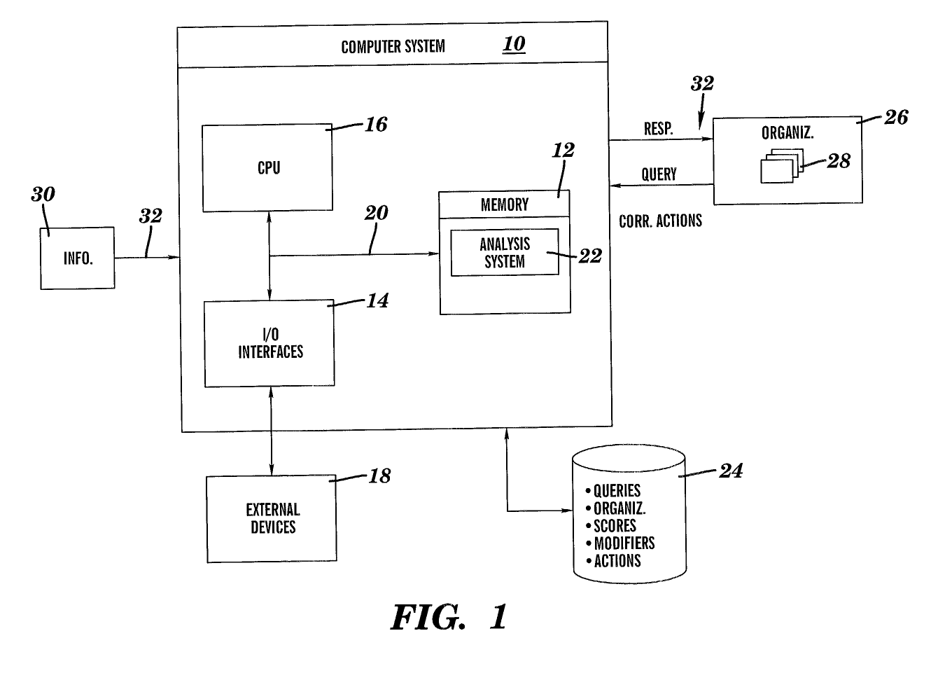

Referring now to FIG. 1, a computer/server system 10 that includes the analysis system 22 of the present invention is shown. The computer system 10 generally comprises memory 12, input/output interfaces 14, a central processing unit (CPU) 16, external devices/resources 18, bus 20, and database 24. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server. I/O interfaces 14 may comprise any system for exchanging information from an external source. External devices 18 may comprise any known type of external device, including a CRT, LED screen, hand held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Stored in memory 12 is analysis system 22 (shown in FIG. 1 as a software product). Analysis system 22 will be described in more detail below but generally comprises a system and method for implementing technical change in an organization 26 having multiple hierarchies 28. Database 24 provides storage for information 30 necessary to carry out the present invention. Such information could include, inter alia: (1) queries to be presented to an organization; (2) organizational information such as the quantity, names, and types of hierarchies; (3) score information (e.g., values attributable to particular responses to queries, required scores, etc.); (4) modifiers and their corresponding values; and (5) potential corrective actions. Database 24 may comprise one or more storage devices, such as a magnetic disk drive or an optical disk drive. In another preferred embodiment, database 24 includes data distributed across, for example, a local area network (LAN), wide area network (WAN) or a storage area network (SAN) (not shown). Database 24 may also be configured in such a way that one of ordinary skill in the art may interpret it to include one or more databases.

As will be described in further detail below, computer system 10 queries one or more selected hierarchies 28 within organization 26. The queried hierarchies will answer the queries with a set of responses, which form a baseline response. As defined above, each hierarchy 28 could represent a different management level, department, position type, individual, etc., within organization 26. Once received, the baseline response is quantified into a raw score and then modified to yield a skill score. The skill score will then be compared to a required score to determine the difference between the two. Based on the difference, certain corrective actions could then be outputted to organization 26. When implemented in organization 26, the corrective actions help reduce or eliminate any adverse reaction to a technical change in the organization.

Communication with computer system 10 by organization 26 or a system administrator (not shown) occurs via communication links 32. Communications links 32 can include a direct terminal connected to the computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. As indicated above, the computer system 10 according to the present invention can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

III. Analysis system

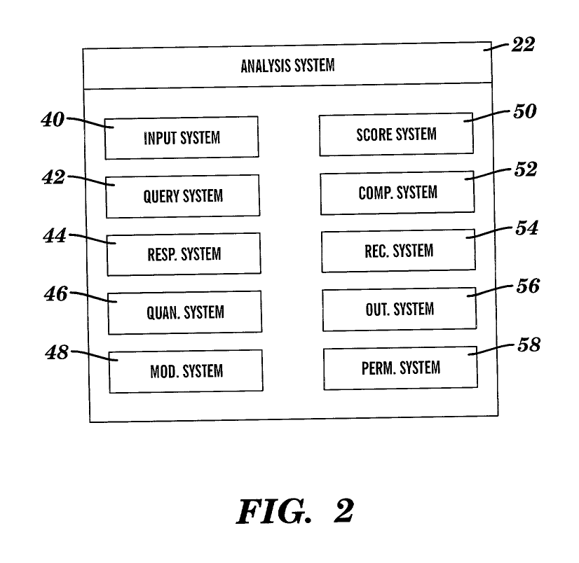

Referring now to FIG. 2, the analysis system 22 is shown in greater detail.

As depicted, analysis system 22 includes an input system 40 that is used to input information. As indicated above, certain information might be necessary to carry out the present invention. Such information could include queries, information pertaining to an organization being analyzed (e.g., quantity, name and types of hierarchies), score information, modifier information, corrective actions, etc. A system administrator, or the like, preferably inputs this information prior to analysis of an organization. It should be understood that this information could change based on the organization or the type of technical change being implemented. For example, the queries and/or modifiers may vary depending on the type of organization being analyzed (as will be described further below). Alternatively, some information (e.g., organizational information) could be inputted via input system 40 by the organization itself. In this case, access to the analysis system 22 could be controlled by a permission/password system 58. Permission system 58 could provide varying levels of access to analysis system 22 so that, for example, organizations can gain access only to input organizational information and view reports pertaining to the analysis of their organization.

To begin the analysis, one or more hierarchies in the organization will be queried. As will be described in further detail below, each query comprises a “set” of questions that are developed to measure a potential response to the technical change being proposed or implemented. It should be understood that a “set” could include any number (i.e., 0, 1, 2 . . . N). Preferably, the queries are grouped into various query topics such as, for example, Leadership, Planning, Administration, Operations, Quality Assurance, Communications, Project Management, and Skills/Training. It should be appreciated that these query topics are illustrative and are not intended to be limiting. Specifically, the query topics and queries could change based on a number of factors such as the type of organization being analyzed, the type of technical change being implemented, etc. The topics discussed herein are intended to provide an illustration of query topics that could be used when for a database-related technical change.

Preferably, the queries are sent electronically to the selected hierarchies by query system 42. Specifically, query system 42 will access the database to retrieve the relevant queries (as denoted by a system administrator). The queries can then be sent (e.g., over the Internet) to the selected hierarchies within the organization. As indicated above, queries can be made to a single hierarchy, multiple hierarchies, or an entire organization depending on the desire of the system administrator and/or the organization. The particular hierarchies queried could depend upon, for example, the technical change being implemented, the size of the organization, etc. In an alternative embodiment, the selected hierarchies could view queries at an interface by directly accessing the query system 42. As described above, analysis system 22 could include permission system 58 could also permit the hierarchies to view and respond to queries at the analysis system 22. This would eliminate the need to transmit the queries as email messages or the like. A set of hierarchy responses to the queries will be received by the hierarchy response system 44. Similar to the queries, the set of hierarchy responses could include any number of responses (i.e., 0, 1, 2 . . . N). In addition, it should be understood that the set of hierarchy responses could be electronically transmitted to response system 44, or submitted directly by the queried hierarchies at an interface.

A set of hierarchy responses represents a baseline response. Depending on the hierarchies queried, it is possible for one or more baseline responses to be determined. For example, there could be a first baseline response representing the set of responses of Senior Management, a second baseline response representing the set of responses of the Information Technology department, and a third baseline response representing the set of responses of the entire organization (i.e., all hierarchies). Similar to the hierarchies that are queried, the particular baseline responses that are measured could depend upon, for example, the type technical change being implemented, the size of the organization, etc.

Once the baseline response(s) have been determined, quantification system 46 will then quantify each baseline response into a value known as a raw score. Quantification can be performed using any method known in the art. Specifically, possible responses to a particular query question could be YES, NO, or SOMETIMES. In this case, quantification system 46 could assign, for example, a value of 3 to YES, a value of 1 to NO, and a value of 2 to SOMETIMES. The sum of the values assigned to all questions in a baseline response could represent the raw score. Preferably, the value that will be assigned to each response in the baseline response was previously stored in the database, and is retrieved by quantification system 46 when quantifying the baseline response into the raw score.

Once quantified, the raw score can then be modified by modification system 48. Specifically, it is often the case that the responses do not paint the entire picture of how an organization will react to a technical change. Accordingly, the raw score can be modified to help reflect some intangibles. Examples of modifiers include stiffness modifiers, and individual modifiers. A stiffness modifier could relate to how a particular type of organization traditionally responds to change (e.g., either change in general, or the particular technical change being proposed/implemented). Specifically, the stiffness modifier could have values that depend on the type of organization being analyzed. For example, an Internet company (generally less resistive to change) may have a stiffness modifier value of 3, while a government agency (more resistive to change) might have a stiffness modifier value of 1. Similarly, an individual modifier could relate to how particular individuals traditionally respond to change. The individual modifiers could be based on any professional (e.g., education) or social (e.g., income level) factor that is deemed to relate to responsiveness to change. Similar to each response, each modifier has a value assigned thereto. These values could be stored in the database and retrieved by modification system 48.

Once the modifiers are identified and values for each have been determined, a mathematical operation (e.g., multiplication) is then performed on the raw score with the modifier values to yield a skill score. For example, the raw score could be multiplied by both modifier values to yield the skill score. It is important to recognize that the particular operation performed on the raw score is not intended to be a limiting part of the present invention. In contrast, it should be understood that modifiers can be taken into account in many different ways when predicting how an organization will respond to the technical change (e.g., the raw score could be multiplied by the stiffness modifier value and then divided by the individual modifier value. Moreover, it should be understood that the modifiers indicated herein are intended to be illustrative only and are not intended to be exhaustive or limiting. For example, an analysis of an organization can include more modifiers, or none at all.

Once the skill score is known, the score system 50 can then determine the required score. As described above, the required score represents the normal response of an organization that has accepted (i.e., not rejected) the technical change. Accordingly, the required score could vary on a number of factors such as, for example, the size and/or type of organization, the particular technical change being implemented, etc. The required score can also be based on a basic value that is modified with requirement modifiers (similar to the raw score being modified to yield a skill score). Examples of requirement modifiers include the type of technical change (e.g., implementation of a new word processing application vs. installation of new hardware), the specific application being implemented (e.g., Microsoft Word), etc. Similar to the skill score, the required score can be the output of a mathematical operation performed on the basic requirement with a modifier. For example, a basic value of 5 could be modified by a factor of 1 for the technical change type modifier and a factor of 2 for the specific application modifier. If the mathematical operation were to take the product of the basic requirement and the modifier values, the required score would be 10 (i.e., 5* 1* 2=10).

It should be understood that the required score could be calculated by score system 50 based on basic value and requirement modifier information contained in the database, or could be determined outside the analysis system by a system administrator and then inputted via input system 40. In the case of the latter, score system 50 would simply access the database to retrieve the inputted required score.

Once retrieved from the database, the comparison system 52 will then compare the required score to the skill score to determine any difference between the two. This is preferably accomplished by taking the mathematical difference between the two scores. The resulting difference (if any) is a prediction of how the organization will respond to the technical change. For example, a difference between the skill score and required score of less than 10 could indicate that little or no adverse reaction will occur, a difference of between 10 and 30 could indicated that a fair amount of adverse reactions will occur, while a difference above 30 could indicate that severe adverse reactions will occur. The difference ranges cited herein, and whether the skill score is subtracted from the required score or vice versa is not intended to be limiting. Rather, they are provided only to provide one illustration of how the present invention could be carried out.

As indicated above, since one or more hierarchies could be queried, one or more baseline responses could result. For each baseline response, a raw score and a skill score can be determined. Then, for each baseline response, a separate response prediction can be made. This allows for an in depth analysis of an organization. For example, a response prediction can be made of the organization as a whole, of a particular department, of a particular individual, etc.

Based on the difference between the skills core and the required score, recommendation system 54 will access the database to retrieve recommended corrective actions. When implemented, the corrective actions are designed to 20 overcome the problems predicted by analysis system 22 so that the technical change can be implemented with little or no adverse reaction. For example, if an organization had a difference between the skill score and the required score of 35, a total lack of understanding of the technical change may be indicated. Thus, a possible corrective action may be to hold training or informational seminars to better educate the organization about the change. Similar to other information stored in the database, the corrective actions could reflect a variety of factors such as the size of the organization, the type of change being implemented, etc. Moreover, the corrective actions are preferably inputted via input system 40.

The corrective actions as well as any reports concerning the analysis made by analysis system 22 could be outputted to the organizations and/or their hierarchies via output system 56. Output system 56 could send such information or could print a hard copy. Alternatively, an organization could access analysis system 22 via password system 58 and view information pertaining to itself via an interface.

It should be appreciated that the precise configuration and functionality of analysis system 22 could be varied. For example, query system 42 and hierarchy response system 44 could exist as a single system. Moreover, an individual or entity outside of analysis system 22 could provide some of the functions provided by analysis system 22. For example, analysis system 22 could provide a system administrator with the skill score. The system administrator could then use a manually calculated required score to manually calculate the difference and recommend corrective actions.

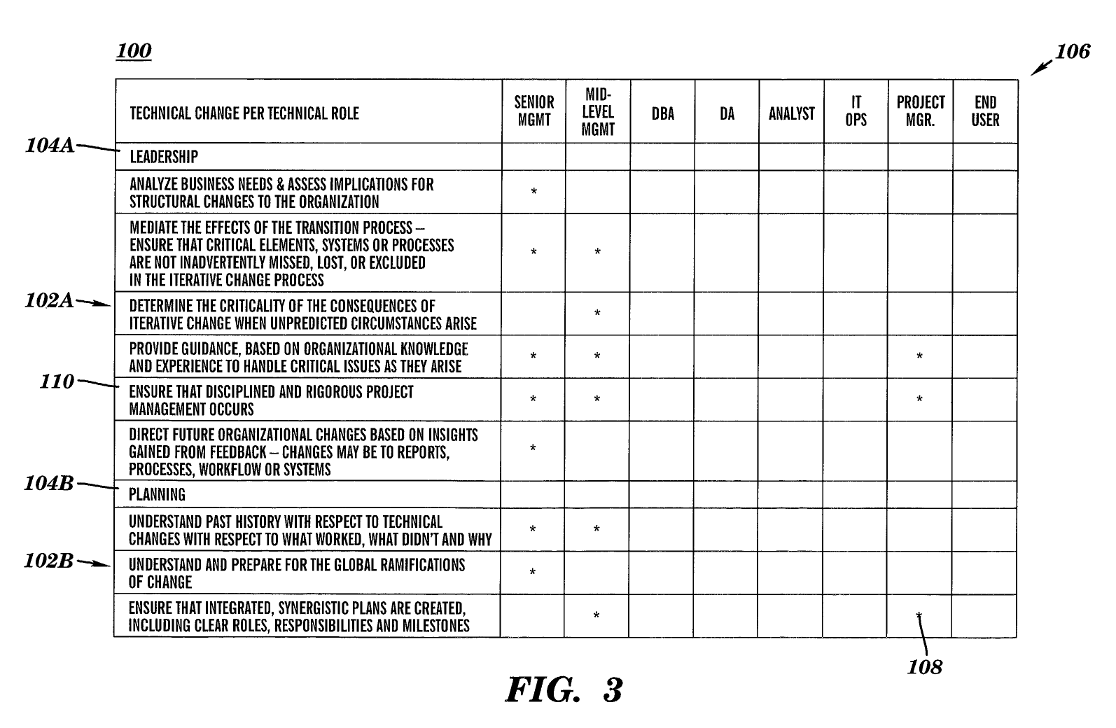

Referring now to FIGS. 3-7 exemplary tables depicting queries and hierarchies for an organization are shown. It should be understood that the information displayed in FIGS. 3-7 is intended to be illustrative only and could vary depending on the particular organization, the type of technical change being implemented, etc. Specifically, the queries and hierarchies depicted in FIGS. 3-7 are examples of potentially relevant queries and hierarchies when implementing a database-related technical change in an organization. As shown in FIG. 3, queries 100 are grouped into query topics 104A-B. The query topics 104A-B shown in FIG. 3, include Leadership 104A and Planning 104B. Moreover, hierarchies 106 include Senior Management, Mid-level Management, Database Administrators, Data Analysts, Analysts, Information Technology Operations, Project Managers, and End Users.

As depicted, each query topic 1 04A-B could include one or more queries 102A-B. As indicated above, each query includes a set of questions (with a set being any quantity such as 0, 1, 2 . . . N). For example, Leadership topic 104A includes six queries 102A. One of the queries in Leadership topic 104A is “Ensure that disciplined and rigorous project management occurs” 110. To answer this query, a hierarchy 106 would be presented with a set of questions aimed at answering this query. Examples of such questions could include: (1) do you oversee Project Managers; and (2) do you meet with Project Mangers routinely to review their performance. Indicators 108 denote the particular hierarchies 106 that will be presented with a particular query. For example, the above-quoted query will be presented to Senior Management, Mid-level Managers, and Project Managers. Selecting hierarchies that are presented with particular queries allows the analysis to be customized and/or focused on particular hierarchies/segments of the organization. It should be understood that the set of questions posed with each query could change depending on the hierarchy. For example, Project Managers might be asked whether they report to a manager, rather than whether they oversee Project Managers.

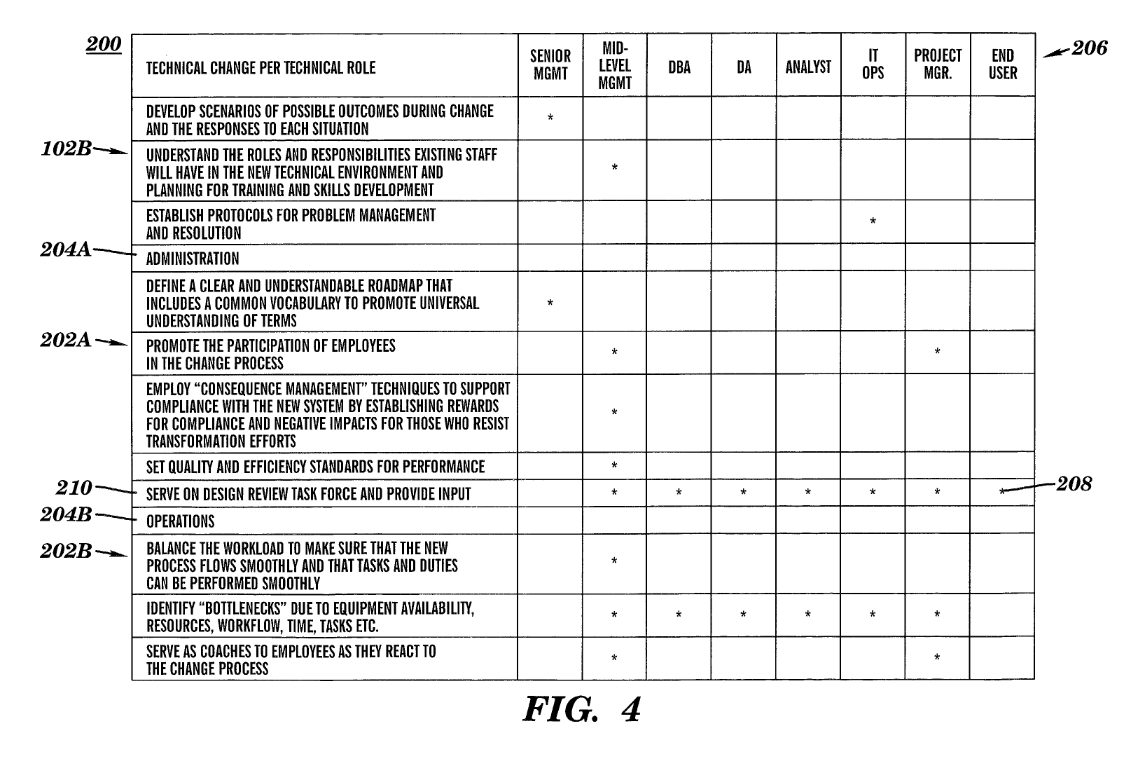

Referring now to FIG. 4, a second exemplary table depicting queries 102B and 202A-B and hierarchies 206 is shown. Queries 102B are a continuation of Planning query topic 104B of FIG. 3. FIG. 4 includes two additional query topics 202A-B. Specifically, Administration query topic 204A and Operations query topic 204B, each having queries 202A and 202B, respectively, are illustrated. Hierarchies 206 remain the same as shown in FIG. 3. Moreover, indicators 208 continue to denote which hierarchies will be presented with particular queries. For example, all hierarchies except for Senior Management will be presented with the query “Serve on design review task force and provide input” 210. To evaluate this query, the indicated hierarchies could be posed with, for example, two questions: (1) do you serve on a design review task force; and (2) do you provide input.

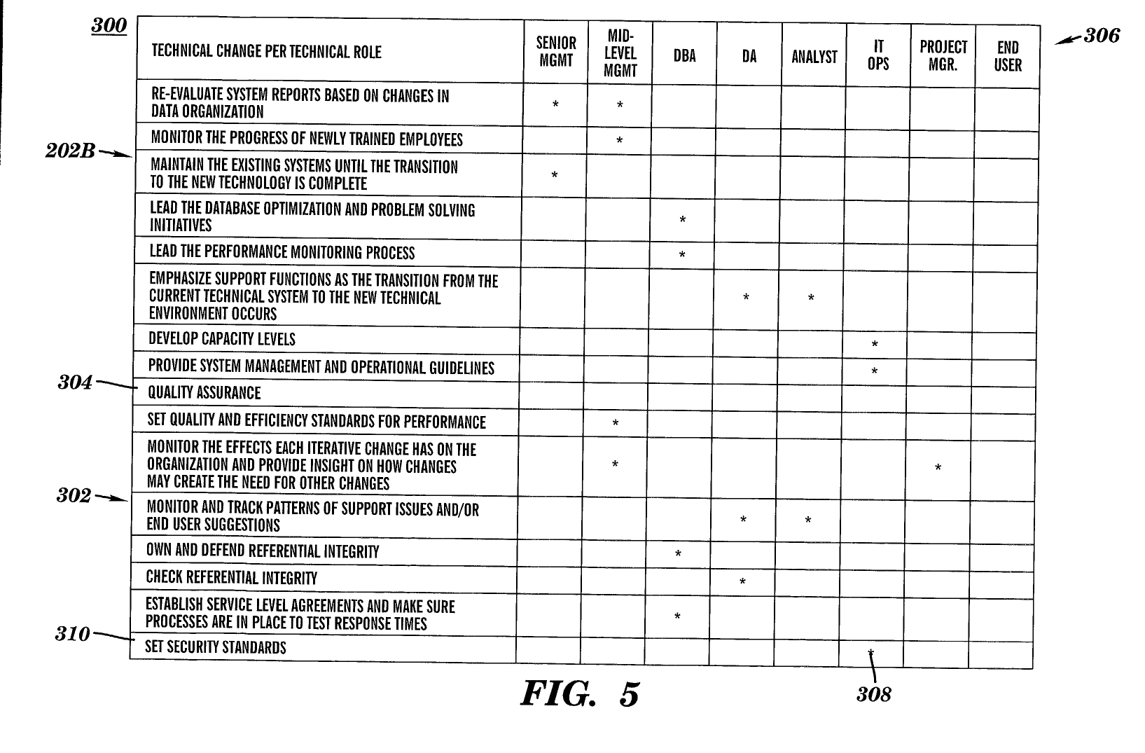

Referring now to FIG. 5, a third exemplary table 300 is depicted. Table 300 includes hierarchies 306 (similar to those shown in FIGS. 3 and 4), Quality Assurance query topic 304, and queries 202B and 302. Queries 202B are a continuation of the Operations query topic 204B shown in FIG. 4. Moreover, indicators 308 denote which hierarchies will be presented with particular queries 202B and 302. For example, the query “Set security standards” 310 will be presented only to the Information Technology hierarchy 306.

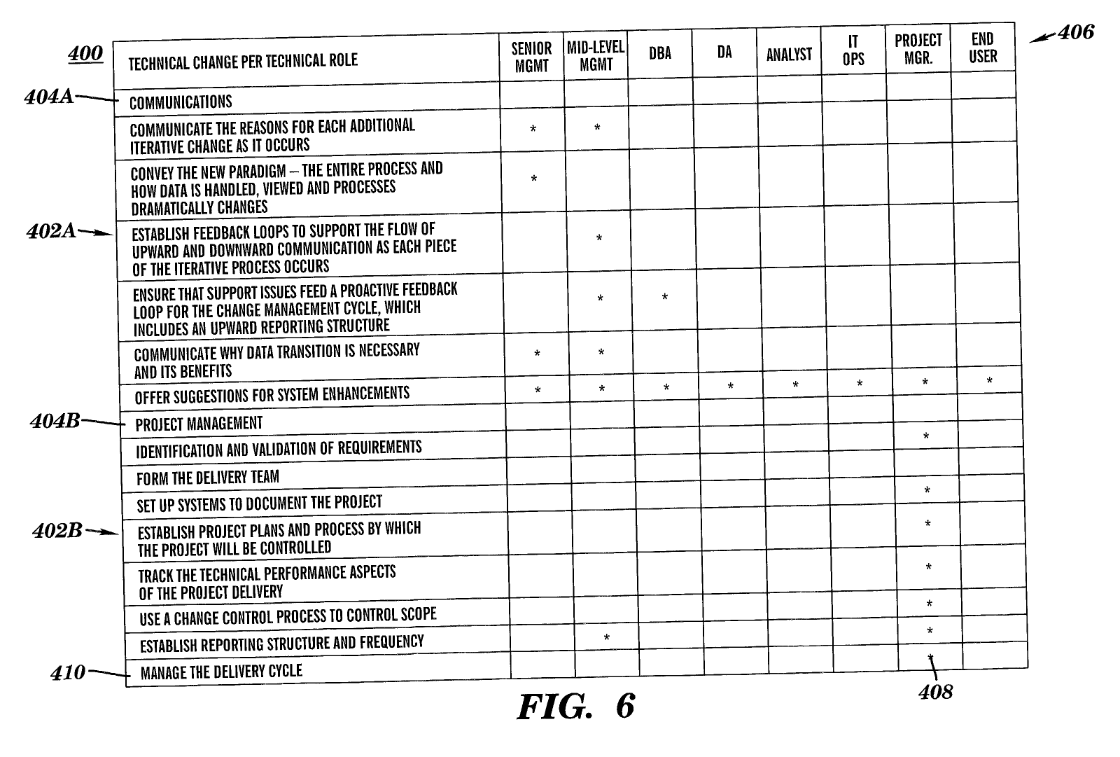

FIG. 6 shows a fourth exemplary table 400 depicting Communications 404A and Project Management 404B query topics, queries 402A-B, hierarchies 406, and indicators 408. Each the queries 402A-B shown in FIG. 6 will be presented to the hierarchies 406 denoted by their respective indicators 408. For example, the query “Manage the delivery cycle” 410 will only be presented the Project Manager hierarchy 406.

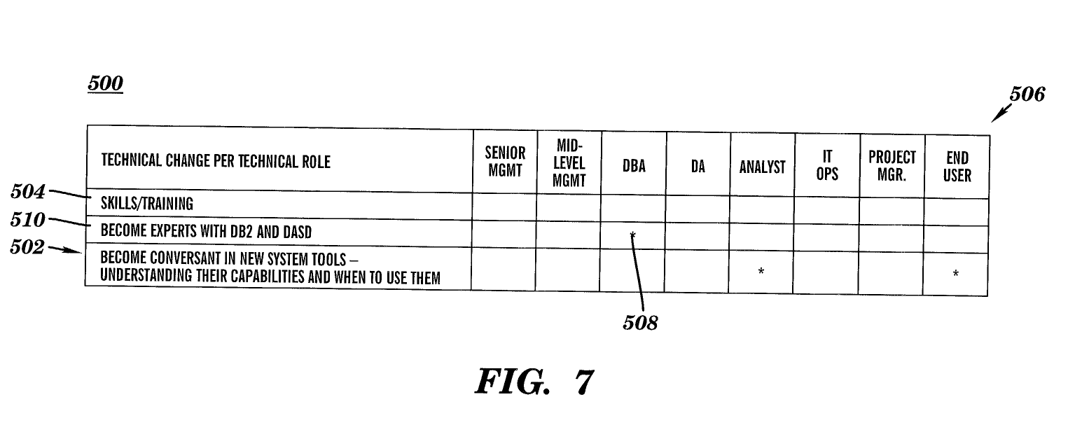

FIG. 7 depicts shows a fifth exemplary table 500 depicting Skills/Training 504 query topic, queries 502, hierarchies 506, and indicators 508. Each the queries 502A-B shown in FIG. 7 will be presented to the hierarchies 506 denoted by their respective indicators 508. For example, the query “Become experts with DB2 and DASD” 510 will only be presented to the Database Administrator hierarchy 506.

As described above, each queried hierarchy will provide a set of responses to their queries. The quantity of responses in the set depends on the quantity of questions posed with each query (e.g., 0, 1, 2 . . . N). Moreover, each response in a set of responses should be in a format capable of being quantified (e.g., YES, NO, or SOMETIMES). Based on the set of responses a baseline response is determined. As indicated above, the baseline response could be the set of responses received from a single hierarchy (e.g., Senior Management), from multiple hierarchies (e.g., Senior Management and Mid-level Management), from an entire organization (e.g., all hierarchies), etc. Once determined, the baseline response will be quantified, modified, and compared to determine a potential response to the technical change. Based upon the response, corrective actions could be recommenced.

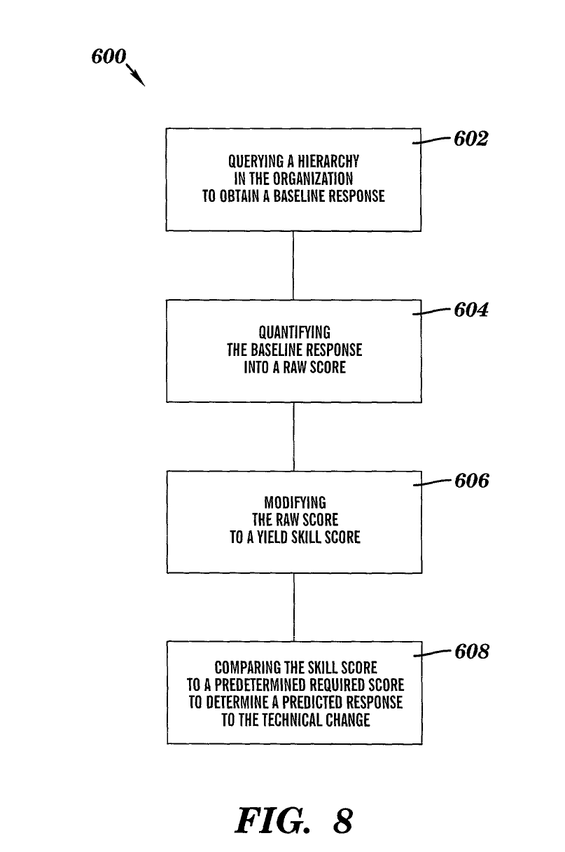

Referring now to FIG. 8, a flow chart of a method 600 according to the present invention is shown. First step 602 of method 600 is to query a hierarchy in the organization to obtain a baseline response. Second step 604 is to quantify the baseline response into a raw score. Third step 606 is to modify the raw score to yield a skill score. Fourth step 608 is to compare the skill score to a predetermined required score to determine a predicted response to the technical change.

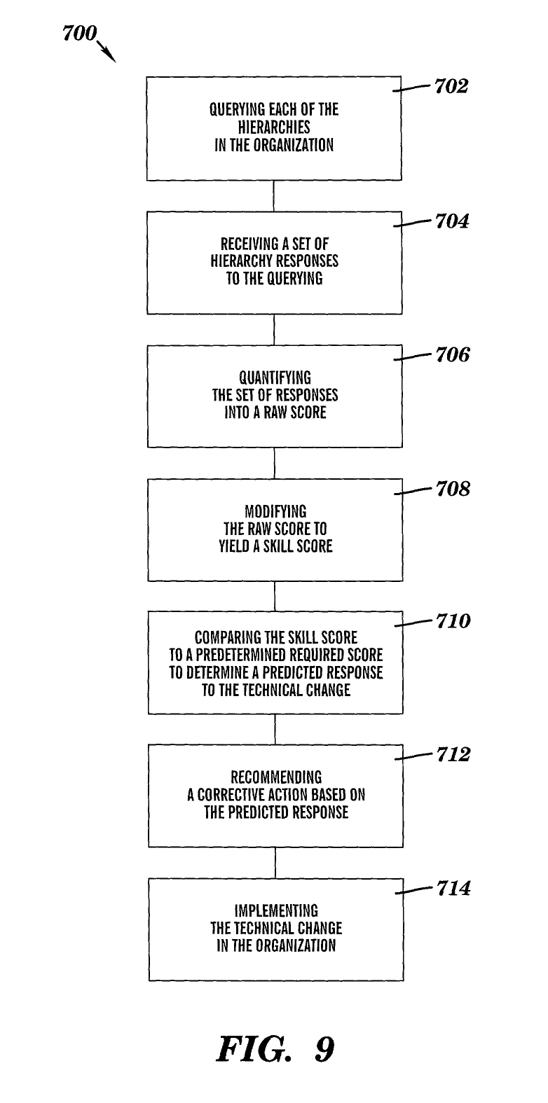

FIG. 9 depicts a flow chart of a second method 700 according to the present invention. The first step 702 is to query each of the hierarchies in the organization. Second step 704 of method 700 is to receive a set of hierarchy responses to the querying. Third step 706 is to quantify the set of responses into a raw score. Fourth step 708 is to modify the raw score to yield a skill score. Fifth step 710 of method 700 is to compare the skill score to a predetermined required score to determine a predicted response to the technical change. Sixth step 712 is to recommend a corrective action based on the predicted response. Seventh step 714 of method is to implement the technical change in the organization.

By analyzing the hierarchies of an organization using various queries, such as those discussed herein, the present invention uses both quantitative and qualitative measures to more efficiently implement technical change in an organization. This system will reduce or eliminate the waste of organizational resources resulting from adverse reaction to the technical change.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for implementing technical change in an organization having multiple hierarchies, comprising the steps of:
querying a hierarchy in the organization to obtain a baseline response;
quantifying the baseline response into a raw score;
modifying the raw score to yield a skill score; and
comparing the skill score to a predetermined required score to determine a predicted response to the technical change.

2. The method of claim 1, further comprising the steps of:
recommending a corrective action based on the predicted response; and
implementing the technical change.

3. The method of claim 1, wherein the querying step the steps of comprises:
querying a hierarchy in the organization; and
receiving a set of hierarchy responses to the querying to yield the baseline response.

4. The method of claim 1, further comprising the step of providing queries organized into query topics for querying the hierarchy.

5. The method of claim 4, wherein the query topics comprise leadership, planning, administration, operations, quality assurance, communications, project management, and training.

6. The method of claim 4, wherein each query comprises a set of questions.

7. The method of claim 1, wherein the hierarchies comprise senior management, mid-level management, administrators, analysts, operations, project management, and end users.

8. The method of claim 1, wherein the querying step comprises the step of querying each of the hierarchies in the organization, and wherein a separate baseline response is obtained for each hierarchy and for the organization.

9. The method of claim 8, wherein each separate baseline response is quantified, modified and compared to a predetermined required score.

10. A method for implementing technical change in an organization having multiple hierarchies, comprising the steps of:
querying each of the hierarchies in the organization;
receiving a set of hierarchy responses to the querying;
quantifying the set of responses into a raw score;
modifying the raw score to yield a skill score;
comparing the skill score to a predetermined required score to determine a predicted response to the technical change;
recommending a corrective action based on the predicted response; and
implementing the technical change in the organization.

11. The method of claim 10, wherein the hierarchies are queried based on queries organized into query topics.

12. The method of claim 11, wherein the query topics comprise leadership, planning, administration, operations, quality assurance, communications, project management, and training.

13. The method of claim 11, wherein each query comprises a set of questions.

14. The method of claim 10, wherein the hierarchies comprise senior management, mid-level management, administrators, analysts, operations, project management, and end users.

15. A program product stored on a recordable medium for implementing technical change in an organization having multiple hierarchies, which when executed, comprises:
a hierarchy response system for receiving a set of hierarchy responses to queries;
a quantification system for quantifying the set of responses into a raw score; and
a modification system for modifying the raw score into a skill score.

16. The program product of claim 15, further comprising:
an input system for inputting information;
a comparison system for comparing the skill score to a predetermined required score to yield a predicted organizational response to the technical change; and
an output system for outputting recommended corrective actions that are based on the predicted response.

17. The program product of claim 15, wherein the quantification system converts the inputted responses into values to yield the raw score.

18. The program product of claim 15, wherein the modification system performs a mathematical operation on the raw score with a modifier to yield the skill score.

19. The program product of claim 15, wherein the comparison system determines the mathematical difference between the skill score and the predetermined required score to yield the predicted response.

20. The program product of claim 15, wherein the queries are organized into query topics, and wherein each query comprises a set of questions.

21. The program product of claim 20, wherein the query topics comprise leadership, planning, administration, operations, quality assurance, communications, project management, and training.

22. The program product of claim 15, wherein the hierarchies comprise senior management, mid-level management, administrators, analysts, operations, project as management, and end users.

23. A system for implementing technical change in an organization having multiple hierarchies, comprising:
a hierarchy response system for receiving a set of hierarchy responses to queries;
a quantification system for quantifying inputted responses into a raw score; and
a modification system for modifying the raw score into a skill score.

24. The system of claim 23, further comprising:
a comparison system for comparing the skill score to a predetermined required score to yield a predicted organizational response to the technical change; and
an output system for outputting recommended corrective actions that are based on the predicted response.

25. The system of claim 24, further comprising:
an input system for inputting information; and
a score system for identifying the required score.

26. The system of claim 24, wherein the comparison system determines the mathematical difference between the skill score and the predetermined required score to yield the predicted response.

27. The system of claim 23, wherein the quantification system converts the inputted responses into values to yield the raw score.

28. The system of claim 23, wherein the modification system performs a mathematical operation on the raw score with modifier to yield the skill score.

29. The system of claim 23, wherein the queries are organized into query topics, and wherein each query comprises a set of questions.

30. The system of claim 29, wherein the query topics comprise leadership, planning, administration, operations, quality assurance, communications, project management, and training.

31. The system of claim 23, wherein the hierarchies comprise senior management, mid-level management, administrators, analysts, operations, project management, and end users.

32. A system for implementing technical change in an organization having multiple hierarchies, comprising:
means for receiving a set of hierarchy responses to queries;
means for quantifying inputted responses into a raw score; and
means for modifying the raw score into a skill score.

33. The system of claim 32, further comprising:
means for inputting information; means for comparing the skill score to a predetermined required score to yield a predicted organizational response to the technical change; and
means for outputting recommended corrective actions that are based on the predicted response.
